(19) United States
(12) Patent Application Publication
(10) Pub. No.: US 2005/0261022 A1
(43) Pub. Date: Nov. 24, 2005

(54) Method of operating a portable electronic device and portable electronic device

(76) Inventors: Paul Camacho, Berlin (DE); Peter Becker, Berlin (DE)

Correspondence Address: Merchant & Gould P.C., P.O. Box 2903, Minneapolis, MN, 55402-0903, US

(21) Appl. No.: 10/847,800

(22) Filed: May 18, 2004

(51) Int. Cl. H04M 1/00

(52) U.S. Cl. 455/556.1; 455/412.1

(57) ABSTRACT

The instant invention relates to a method of operating a portable electronic device and to an electronic device, especially a mobile radio telephone apparatus on which a dictating application for recording, storing, reproducing and/or processing speech input is executed. Depending on an automatically determined operating state of the dictating application, a display means of the portable electronic device displays a menu of functions of the dictating application, adapted to the particular operating state of the dictating application, the functions being selectable by a user by way of an input means of the portable electronic device.

The invention relates to a method of operating a portable electronic device, especially a mobile radio telephone apparatus, and to a portable electronic device.

Different functionalities which users, formerly, had to execute with different, separate devices now are being integrated more and more in portable electronic devices that are capable of receiving information in the form of electronic data. Electronic devices for separate usage, for instance, include mobile radio telephones which allow speech communication, electronic diaries (PDA—personal digital assistants), and also laptop computers. At first, these different portable electronic devices offered users different user functions. In the meantime, however, users desire electronic devices with which the various user functions can be fullfilled by just one electronic device, if possible.

To meet such demand, for example, functions which are executable by a handheld dictaphone in connection with speech input recordings, such as the recording and play-back of dictations, have been made available for execution also by an application program on laptop computers, mobile phones, or electronic PDAs. Typically, the electronic devices dispose of the system prerequisites for implementing this dictating application, namely a microphone means for recording speech input, a loudspeaker means for reproducing recorded speech inputs, and processor technology with memory means for storing and processing speech data.

Use of the system components in the context of a dictating application is made possible by an application program adapted to the respective electronic device and implemented on the electronic device. With known electronic devices it is likewise possible, as a rule, to transmit electronically stored speech data to another electronic device either by a wireless or a wired telecommunications link. Furthermore, it is often possible to withdraw a removable storage medium, such as a memory board of suitable format for a respective electronic device from that electronic device with the implemented dictating application and put it into another electronic device so as to process the speech data recorded on it, for instance to write a text as dictated.

Although it is advantageous for the user of such electronic devices to have a dictating application at his or her disposal a problem exists inasmuch as the electronic devices are not designed for executing the dictating function as would be the case, for instance, with a handheld dictaphone having ergonomically optimized acutation keys or buttons. Because of this disadvantage, the dictating functions available on portable electronic devices, such as mobile phones or PDAs, are hardly used at all.

It is an object of the invention to indicate an improved method of operating a portable electronic device as well as an improved portable electronic device offering a user simplified handling of the portable electronic device in combination with a dictating application.

Accordingly, the invention provides a method of operating a portable electronic device, especially a mobile radio telephone on which a dictating application for recording, storing, reproducing, and/or processing a speech input is executed by means of an application program. Memory data for a plurality of operating states of the dictating application are stored in a memory means included in the portable electronic device. The multiple operating states each are defined by characteristic dictation parameters of a speech input record. The memory data comprise information about menus of functions of the dictating application defined for respective operating states and to be selected by a user by way of an input means of the portable electronic device, a menu defined for a respective operating state and to be displayed on a display means of the portable electronic device in case of the respective operating state. The method further comprises the following steps: determining a current operating state of the dictating application by way of a control means included in the portable electronic device, the operating state being defined by current characteristic dictation parameters of a current speech input record, comparing the current operating state determined for the current speech input record with the memory data for the plurality of operating states of the dictating application, selecting, on the basis on the comparison, a menu of functions of the dictating application corresponding to the current operating state determined, by the control means, and causing the selected menu of functions of the dictating application to be displayed on the display means, by the control means.

The substantial advantage achieved by this method over the prior art is to be seen in the fact that, during execution of a dictating application and depending on the operating state, the user can be shown a menu of functions of the dictating application adapted to the respective operating state. The menu may be optimized, for instance, so that only part of the functions available in the dictating application is placed at the user's disposal to be chosen from. The user is automatically offered an individually adapted menu depending on the operating state of the dictating application, such as an operating state at the beginning of a dictation or an operating state at the end of a dictation. Thus it is unnecessary to present all the functions of the dictating application for each operating state of the dictating function to the user to make his/her choice. Those functions of the dictating application, for example, are “recording”, “playing”, “inserting”, “forward winding” and the like, of all of which, as a rule, only some are executable in connection with a particular operating state. If it is found, for instance, when determining the operating state, that the recording of the speech input has not started as yet, which means that this is an operating state at the beginning of the recording of a dictation, it is useless to present the function “reverse winding”.

Devising the method in the manner described when operating the portable electronic device makes it easier for the user to manipulate the portable electronic device in connection with the dictating application because the display means always presents an optimized menu comprising certain functions of the dictating application, in response to the operating state. Moreover, the optimized menu can be handled efficiently via the input means which usually is miniaturized in the case of portable electronic devices.

A convenient modification of the invention provides for using, as characteristic dictation parameters, an overall length (L) between a beginning and an end of the speech input record and a working position (P) between the beginning and the end of the speech input record. And, when determining the current operating state of the dictating application, a current overall length (mL) between a beginning and an end of the current speech input record and a current working position (mP) between the beginning and the end of the current speech input record are determined. Thus the current operating state of the dictating application can be determined efficiently. This choice of parameters, moreover, permits the number of possible operating states to be reduced to four possible operating states.

It may be provided, with a preferred embodiment of the invention, to use a dynamic working state as another characteristic dictation parameter of the speech input record to indicate a playing, recording, and/or winding state of the speech input record. Hereby a greater variety of operating states may be taken into account, if desired.

The method may be used advantageously in combination with any desired portable electronic device. The advantages of the method unfold their effect especially in combination with portable electronic telecommunications devices, such as mobile radio telephone apparatus which are adapted to exchange electronic data via wireless telecommunication links. Mobile radio telephone apparatus inherently have entry windows of limited size, including keys and/or joystick elements. The optimized provision of menus offered by the method takes into account the conditions of these devices, for instance, by presenting in particular only those functions of the dictating application which are useful/necessary for the respective operating state.

The invention will be described further, by way of example, with reference to the accompanying drawings, in which:

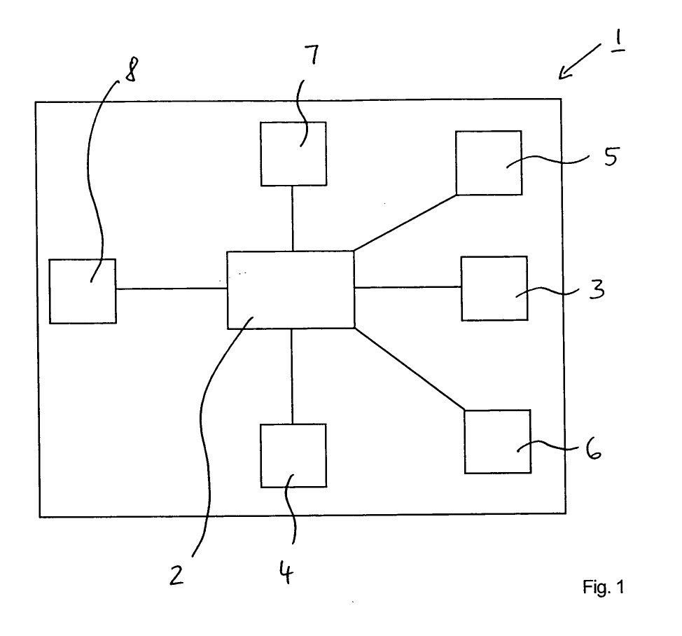

FIG. 1 is a diagrammatic illustration of a portable electronic device; and

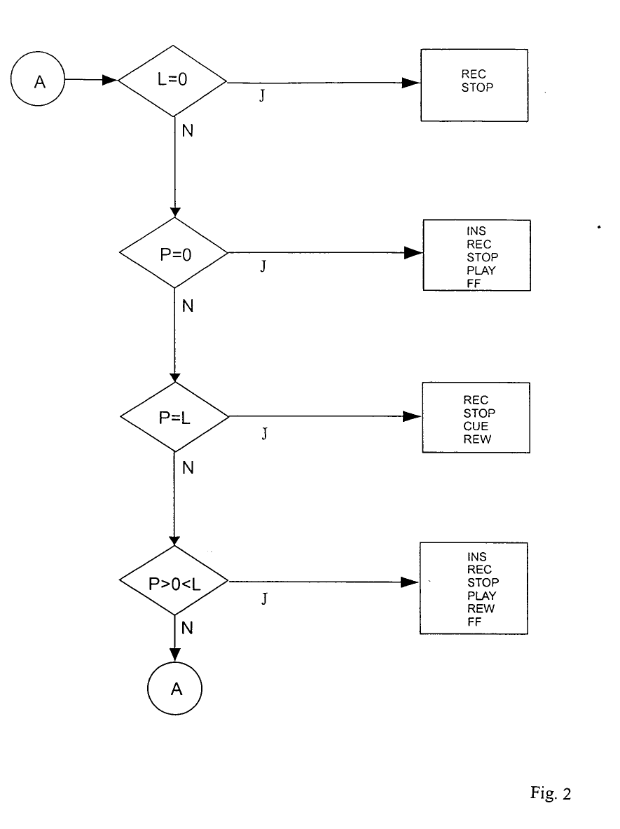

FIG. 2 is a flowchart illustrating a method of operating the portable electronic device in combination with a dictating application, with which only four operating states are taken into account.

FIG. 1 is a diagrammatic presentation of a portable electronic device 1 which may be a mobile phone, a PDA, or a laptop computer. A control means 2 embodied, for example, by a microprocessor suitable for the various types of electronic devices controls system components of the portable electronic device 1 and the electronic data exchange between the system components by suitable instructions. The diagrammatic illustration of the coupling of system components shown in FIG. 1 and the following description of their cooperation are chosen merely as an example and may vary for different electronic devices without affecting the implementation of the invention. A person skilled in the art will readily adapt the invention to any given system configuration of a respective electronic device.

As shown in FIG. 1, the portable electronic device 1 disposes of a microphone 3 for recording speech input, a loudspeaker 4 for emitting audio data, a display means 5 for displaying graphic information, especially user information, such as menus including functions for the user to pick from and enter by an input means 6 for execution, as well as a memory 7 for storing electronic data. FIG. 1 also shows that the portable electronic device 1 comprises a transmitter/receiver unit 8 for transmitting and receiving electronic data to and from other devices either via a wireless or a wired data connection.

A dictating application is implemented on the portable electronic device 1 by an application program which is adapted to the system configuration of the portable electronic device 1. Such dictating applications are known per se for various portable electronic devices, such as mobile phones or PDAs. The dictating application allows a user of the portable electronic device 1 to enter speech through the microphone 3. The speech input will be converted into electronic data, more specifically digital data. The electronic data will be stored by the control means 2 in the memory 7.

The dictating application comprises several functions to be selected by the user of the portable electronic device 1 in order to be executed upon actuation of the input means 6. Among the functions of the dictating application, a distinction may be made between functions relating to the process of recording a dictation and functions concerned with the handling of data sets of dictations which have been recorded. The functions of the dictating application relating to the process of recording a dictation especially comprise the following functions: recording (REC), reproducing or playing (PLAY), forward winding (FF), reverse winding (REW), stopping (STOP), as well as inserting (INS). An additional function is included, namely CUE. The execution of CUE, when selected by the user of the dictating application, will cause the dictation record to be wound in reverse for a short piece from the current position, a kind of short backspace, of a few seconds for instance, then be played again, and subsequently the dictation may be continued. These functions of the dictating application which the user may choose to employ when recording a dictation are known per se. The functions of the dictating application relating to the handling of data sets of a recorded dictation comprise such things as generating, transmitting/receiving, copying, and/or cancelling data sets. These functions of a dictating application likewise are known per se and may be implemented by someone skilled in the art on any respective portable electronic device by means of a suitable application program.

Tables 1 and 2 below give overviews of operating states of the dictating application on the portable electronic device 1. The various operating states are distinguished according to the following characteristic parameters: overall length (L) between a beginning and an end of a dictation record, working position (P) between the beginning and the end of the dictation record, and dynamic working state (Z) indicating a playing, recording, and/or winding state of the dictation record. A menu including one or more functions of the dictating application is allocated to each of the operating states. The embodiment according to table 1 comprises a total of four operating states, whereas the embodiment according to table 2 comprises six operating states.

TABLE 1

| Operating state | Menu |
|---|---|
| L = 0 | REC |
| P = 0 | STOP |
| L > 0 | INS |
| P = 0 | REC |
| | STOP |
| | PLAY |
| | FF |
| L > 0 | REC |
| P ≈ L | STOP |
| | CUE |
| | REW |
| L > 0 | INS |
| 0 < P < L | REC |
| | STOP |
| | PLAY |
| | REW |
| | FF |

TABLE 2

| Operating state | Menu |
|---|---|
| P ≠ Ø | REC |
| L ≠ Ø | |
| L > Ø | INS |
| P = Ø | REC |
| | PLAY |
| | FF |
| L > 0 | REC |
| | CUE |
| P ≠ L | REW |
| L > 0 | INS |
| 0 < P < L | REC |
| | PLAY |
| | REW |
| | FF |
| L > 0 | STOP |
| 0 < P < L | REW |
| Z ? | FF |
| L > 0 | STOP |
| 0 < P < L | PLAY |
| Z ? | |

When operating the portable electronic device 1 according to FIG. 1 within the scope of a dictating application the following process is carried out. Memory data comprising information which relates to the plurality of operating states of the dictating application are stored in the memory 7 of the portable electronic device 1. As follows from tables 1 and 2, the plurality of operating states each are defined by characteristic dictation parameters of the dictation record. In the case of the embodiment represented by table 1, these are the characteristic dictation parameters P and L, whereas the embodiment represented by table 2 includes dictation parameter Z in addition. Moreover, the memory data include information as to the menu of functions of the dictating application for use with the respective operating state of the dictating application. The respective menus may be gathered from tables 1 and 2 for the two different embodiments. The memory 7 thus comprises information about each given menu of functions of the dictating application, as defined for the respective operating state.

In a dictating application, the control means 2 finds out a current operating state of the dictating application. With the embodiment according to table 1, this means determining a current overall length (mL) of the dictation record and a current working position (mP) within the overall length of the dictation record. In response to the location of the current working position (mP), at the beginning or at the end of the dictation record or somewhere in between, a comparison of the current values determined with memory data stored in the memory 7 will help to select a corresponding menu of functions of the dictating application which then will be displayed on the display means 5. Thus the user of the portable electronic device 1 may select a function from this menu and enter it by the input means 6 in order to continue with the dictating application in the form of further recording (REC) or forward winding (FF), for example.

The method described for the embodiment according to table 1 is illustrated diagrammatically in FIG. 2 in the form of a flowchart.

As may be gathered from tables 1 and 2, each of the menus in the various operating states comprises only a limited number of functions of the dictating application which make sense to be carried out by the user in the respective operating state. In contrast to known dictating applications, it is not provided here to confront the user at any point in time of carrying out the dictating application with as many actuating functions as possible when there is nothing but a minute likelihood that a certain function will be selected by the user and consequently the likelihood of its execution is almost nil. Instead, a portable electronic device and a method of operating the portable electronic device are suggested which both are ergonomically optimized. The invention enables persons skilled in the art to implement both in different portable electronic devices, making use of dictating applications which are known per se.

The features of the invention disclosed in the specification above, in the claims, and drawings may be significant to implementing the invention in its various embodiments, both individually and in any combination.

1. A method of operating a portable eletronic device, especially a mobile radio telephone apparatus on which a dictating application for recording, storing, reproducing, and/or processing speech input is executed by means of an application program, wherein
memory data for a plurality of operating states of the dictating application are stored in a memory means included in the portable electronic device,
the plurality of operating states each are defined by characteristic dictation parameters of a speech input record,
the memory data comprise information about menus of functions of the dictating application defined for respective operating states and to be selected by a user by way of an input means of the portable electronic device, a menu defined for a respective operating state and to be displayed on a display means of the portable electronic device in case of the respective operating state, and
the method further comprising the following steps:
determining a current operating state of the dictating application by way of a control means included in the portable electronic device, the operating state being defined by current characteristic dictation parameters of a current speech input record,
comparing the current operating state determined for the current speech input record with the memory data for the plurality of operating states of the dictating application,
selecting a menu of functions of the dictating application corresponding to the current operating state determined, on the basis on the comparison by the control means,
causing the selected menu of functions of the dictating application to be displayed on the display means by the control means.

2. The method as claimed in claim 1, characterized in that characteristic dictation parameters used are an overall length (L) between a beginning and an end of the speech input record, and a working position (P) between the beginning and the end of the speech input record, a current overall length (mL) between a beginning and an end of the current speech input record and a current working position (mP) between the beginning and the end of the current speech input record being determined, when determining the current operating state of the dictating application.

3. The method as claimed in claim 1, characterized in that another characteristic dictation parameter of the speech input record used is a dynamic working state which indicates a state of playing, recording, and/or winding of the speech input record.

4. The method as claimed in claim 1, characterized in that the selected menu is displayed on the display means by optical highlighting of the menu selected from an overall menu as compared to other functions of the dictating application.

5. The method as claimed in claim 1, characterized in that a first current operating state is determined and a first menu is displayed on the display means, comprising the following function of the dictating application: “record”.

6. The method as claimed in claims 2 and 5, characterized in that when determining the first current operating state: mL=0 and mP=0 are determined.

7. The method as claimed in claim 1, characterized in that a second current operating state is determined and a second menu is displayed on the display means, comprising the following functions of the dictating application: “insert”, “record”, “stop”, “play”, and “forward wind”.

8. The method as claimed in claims 2 and 7, characterized in that when determining the second current operating state: mL>0 and mP=0 are determined.

9. The method as claimed in claim 1, characterized in that a third current operating state is determined and a third menu is displayed on the display means, comprising the following functions of the dictating application: “record”, “stop”, “reverse wind/play/record” and “reverse wind”.

10. The method as claimed in claims 2 and 9, characterized in that when determining the third current operating state: mL>0 and mP≈L are determined.

11. The method as claimed in claim 1, characterized in that a fourth current operating state is determined and a fourth menu is displayed on the display means, comprising the following functions of the dictating application: “insert”, “record”, “stop”, “play”, “reverse wind” and “forward wind”.

12. The method as claimed in claims 2 and 11, characterized in that when determining the fourth current operating state: mL>0 and 0<mP<L are determined.

13. A portable eletronic device, especially a mobile radio telephone apparatus on which a dictating application for recording, storing, reproducing, and/or processing speech input is implemented for execution by means of an application program, wherein
memory data for a plurality of operating states of the dictating application are stored in a memory means,
the plurality of operating states each are defined by characteristic dictation parameters of a speech input record,
the memory data comprise information about menus of functions of the dictating application defined for respective operating states and to be displayed on a display means as the respective menu for the respective operating state,
an input means is provided to detect user entries for selecting the functions of the dictating application, and
a control means is provided, the control means comprising:
working means for determining a current operating state of the dictating application, the operating state being defined by current characteristic dictation parameters of a current speech input record,
comparing means for comparing the current operating state determined for the current speech input record with the memory data for the plurality of operating states of the dictating application,
selecting means for selecting a menu of functions of the dictating application corresponding to the current operating state determined, on the basis of the comparison, and
controlling means for causing the selected menu of functions of the dictating application to be displayed on the display means.

14. The portable electronic device as claimed in claim 13, characterized in that the working means are configured to determine a current overall length (mL) between a beginning and an end of the speech input record, and a current working position (mP) between the beginning and the end of the current speech input record, when determining the current operating state of the dictating application.

15. The portable electronic device as claimed in claim 13, characterized in that the working means are configured to determine a dynamic working state which indicates a state of playing, recording, and/or winding of the speech input record, as another characteristic dictation parameter of the speech input record, when determining the current operating state of the dictating application.

16. The portable electronic device as claimed in claim 13, characterized in that the control means is configured to cause a first menu comprising the function “record” to be displayed on the display means, with the assistance of the controlling means, when a first current operating state is determined with which mL=0 and mP=0.

17. The portable electronic device as claimed in claim 13, characterized in that the control means is configured to cause a second menu comprising the functions “insert”, “record”, “stop”, “play”, and “forward wind” to be displayed on the display means, with the assistance of the controlling means, when a second current operating state is determined with which mL>0 and mP=0.

18. The portable electronic device as claimed in claim 13, characterized in that the control means is configured to cause a third menu comprising the functions “record”, “stop”, “reverse wind/play/record” and “reverse wind” to be displayed on the display means, with the assistance of the controlling means, when a third current operating state is determined with which mL>0 and mP≈L.

19. The portable electronic device as claimed in claim 13, characterized in that the control means is configured to cause a fourth menu comprising the functions “insert”, “record”, “stop”, “play”, “reverse wind” and “forward wind” to be displayed on the display means, with the assistance of the controlling means, when a fourth current operating state is determined with which mL>0 and 0<mP<L.

20. A computer program product for operating a portable electronic device, especially a mobile radio telephone apparatus on which a dictating application for recording, storing, reproducing, and/or processing speech input is executed by means of an application program, wherein
memory data for a plurality of operating states of the dictating application are stored in a memory means included in the portable electronic device,
the plurality of operating states each are defined by characteristic dictation parameters of a speech input record,
the memory data comprise information about menus of functions of the dictating application defined for respective operating states and to be selected by a user by way of an input means of the portable electronic device, a menu defined for a respective operating state being displayed on a display means of the portable electronic device upon selection of the function of the dictating application,
the product comprising the following means:
means recorded on an electronic data carrier for determining a current operating state of the dictating application as defined by current characteristic dictation parameters of a current speech input record with the assistance of a control means included in the portable electronic device;
means recorded on the electronic data carrier for comparing the current operating state determined for the current speech input record with the memory data for the plurality of operating states of the dictating application;
means recorded on the electronic data carrier for selecting a menu of functions of the dictating application corresponding to the current operating state determined, on the basis of the comparison by the control means; and
means recorded on the electronic data carrier for causing the selected menu of dictating functions to be displayed on the display means by the control means.
